(19) United States
(12) Patent Application Publication
(10) Pub. No.: US 2022/0342801 A1
(43) Pub. Date: Oct. 27, 2022

(54) SYSTEM, METHOD, AND COMPUTER PROGRAM FOR ARTIFICIAL INTELLIGENCE DRIVEN AUTOMATION FOR SOFTWARE TESTING

(71) Applicant: Amdocs Development Limited, Limassol (CY)

(72) Inventors: Itsik David, Petach Tiqwa (IL); Meni Kadosh, Ashkelon (IL); Jinendra Ghodke, Pune (IN)

(21) Appl. No.: 17/242,052

(22) Filed: Apr. 27, 2021

(51) Int. Cl. G06F 11/36; G06N 20/00

(52) U.S. Cl. CPC G06F 11/3688; G06N 20/00; G06F 11/3684; G06F 11/3692

(57) ABSTRACT

As described herein, a system, method, and computer program are provided for artificial intelligence (AI) driven automation of application testing. In use, one or more input data sources for an application are processed, using AI, to determine one or more automation objects or nuggets of the application. Supported application or platforms includes Web, API, Mobile devices, Windows or desktop application, power builder applications. Additionally, automated testing is created for the application, based on one or more elements displayed in the application. The system also supports detecting a failure of the automated testing, by identifying the changes in the application elements or nuggets. Failures of the automation can be automatically fixed and deployed to all the impacted automation scripts.

### FIELD OF THE INVENTION

The present invention relates to application testing.

### BACKGROUND

Application testing is an important step in the application development lifecycle. While it is generally understood that testing can be used to detect application failures, testing can also be used to ensure that requirements defined for an application are met, such as performance, usability, quality, etc. While in the past manual testing was the primary method of testing applications, the development of various automated testing techniques has improved the testing process. For example, automated testing generally reduces testing time and increases testing coverage.

However, currently there are still many limitations associated with currently available automated testing techniques, such as those relying on optical character recognition (OCR) which is costly and those that support only application programming interface (API)-based testing. In part, existing automated testing techniques can be difficult to adopt for applications that significantly change with each release, particularly because automation maintenance may be extremely high as it is tightly coupled with application changes. Additionally, existing automation tools (software) which typically provide different test coverage can be difficult to integrate. There is thus a need for addressing these and/or other issues associated with the prior art.

### SUMMARY

As described herein, a system, method, and computer program are provided for artificial intelligence (AI) driven automation of application testing. In use, one or more input data sources for an application are processed, using AI, to determine one or more automation objects or nuggets of the application. Additionally, automated testing is created for the application, based on the one or more elements displayed in the application.

### BRIEF DESCRIPTION OF THE DRAWINGS

FIG. 1 illustrates a method for AI driven automation of application testing, in accordance with one embodiment.

FIG. 2 illustrates a method for AI driven automation of application testing, in accordance with one embodiment.

FIG. 3 illustrates an exemplary graphical user interface (GUI) for inputting a data source for an application, in accordance with one embodiment.

FIGS. 4A-D illustrate exemplary GUIs for automating application capabilities, in accordance with one embodiment.

FIG. 5 illustrates a network architecture, in accordance with one possible embodiment.

FIG. 6 illustrates an exemplary system, in accordance with one embodiment.

### DETAILED DESCRIPTION

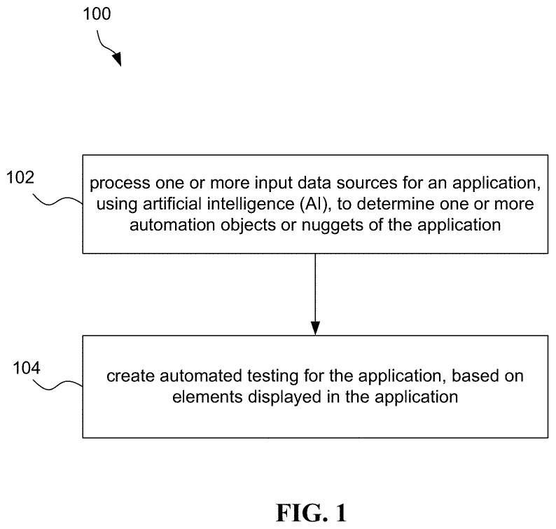

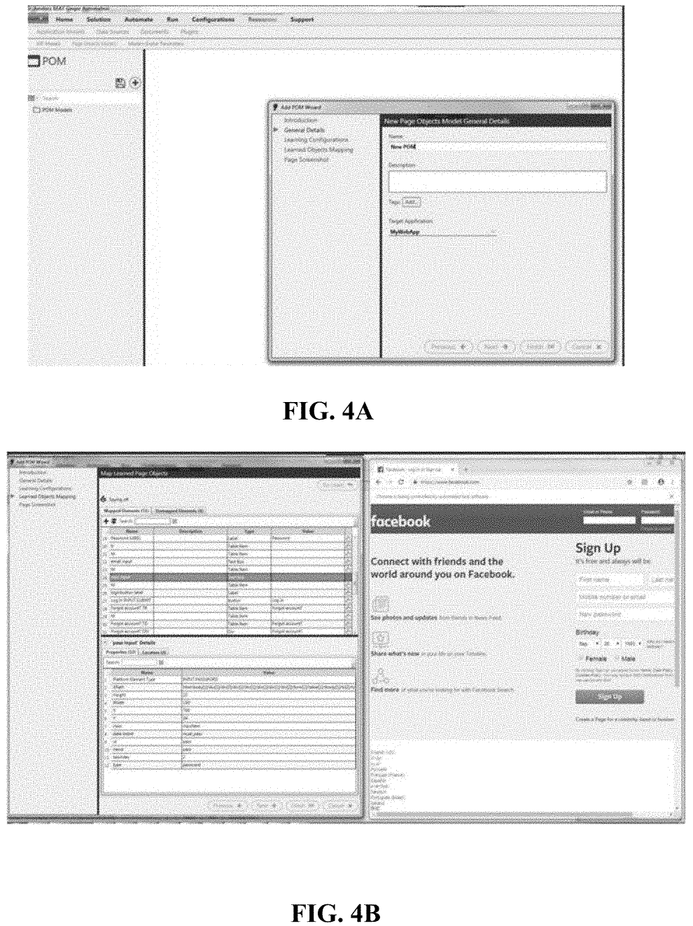

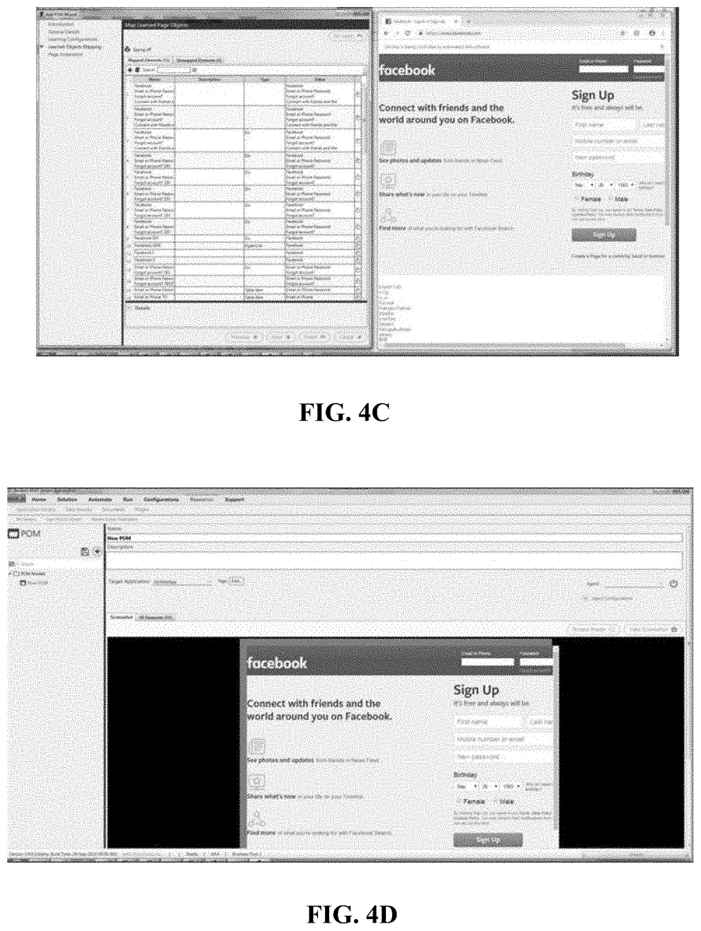

FIG. 1 illustrates a method 100 for AI driven automation of application testing, in accordance with one embodiment. In particular, the following is a high level description of AI driven automation by learning an application and building automatically a business automation flow for execution. The method 100 may be performed by any computer system described below with respect to FIGS. 4 and/or 5. For example, the method 100 may be performed by an automation testing server locally or remotely located with respect to an application to be tested.

In operation 102, one or more input data sources for an application are processed, using AI, to determine one or more automation objects or nuggets (e.g. features) of the application. The application may be a web application, a local (desktop) application, etc. Each input data source may be any type of data source from which one or more features of the application can be learned. For example, the input data source may be application programming interface (API) documentation, such as Web Services Description Language (WSDL) or SWAGGER, defining the application, or a uniform resource locator (URL) to the web application, or an application window itself. The one or more input data sources may be indicated by a user via a GUI of a desktop-based application, as an option.

The one or more features of the application that are determined using the machine learning may include capabilities of the application, in one embodiment. These capabilities may be included in a frontend of the application, a backend of the application, a database utilized by the application, and/or APIs of the application. In another embodiment, the one or more features of the application may include a flow of the application. In other embodiments, the one or more features of the application may include objects within the application, web pages within the application, embedded webpages within application, nested frames, (Infragistics) user interface (UI) controls within application, and/or inactive capabilities of the application. In yet other embodiments, the one or more features of the application may include attributes and properties of the application. As an option, a repository of the one or more features of the application may be created.

In operation 104, automated testing is created for the application, based on elements displayed in the application. For example, the automated testing may be created based on API templates, Document Object Model (DOM) of the website, an application window, and/or screenshot captures collected from the determined features of the application. In one embodiment, the automated testing for the application may include automated testing of APIs of the application. In another embodiment, the automated testing for the application may include automated testing of web pages of the web application and/or mobile devices accessing the web application, or GUIs of a desktop application. In various examples, the automated testing for the application may include automated testing of windows, PowerBuilder, or any desktop application. The automated testing may be progression testing and/or regression testing.

Still yet, the automated testing for the application may be executed. Further, a failure of the application and/or the automation may be detected, by identifying changes in application elements or nuggets. The failure of the application may refer to an error in the application or a failure of the application to meet a defined requirement. For failure of the automation, the automated testing may be fixed by relearning the application capabilities and identifying a delta. The relearned capability compares between two versions of the saved object. In one embodiment, it can be a web page newly release and in other embodiment it can be new API document released.

To this end, the method 100 may be executed to provide AI driven automation of application testing by using machine learning to determine (learn) features of the application, which can then be used to create automated testing for the application. This method 100 may allow the automated testing for the application to be created in parallel with development of the application, while eliminating the need for manual testing or test creating otherwise covered by the created automated testing.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

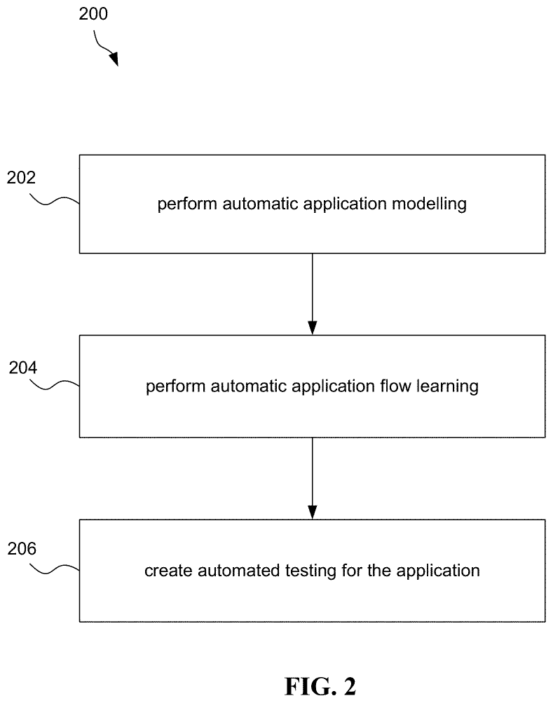

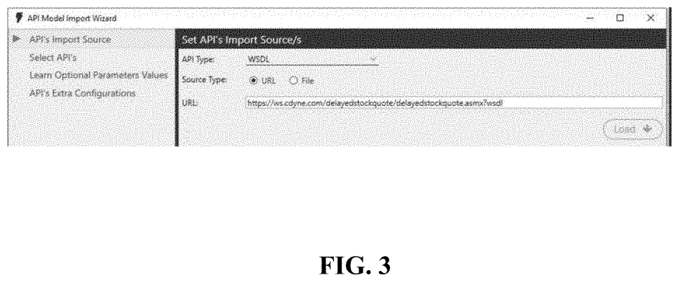

FIG. 2 illustrates a method 200 for AI driven automation of application testing, in accordance with one embodiment. For example, the method 200 relates to modeling a new application via automatic learning all relevant elements. As an option, the method 200 may be carried out in the context of the details of the previous figure and/or any subsequent figure(s). Of course, however, the method 200 may be carried out in the context of any desired environment. Further, the aforementioned definitions may equally apply to the description below.

In operation 202, application modelling is automatically performed. The application modelling refers to determining capabilities of the application. The capabilities may exist in a frontend, backend, database, and/or APIs of the application. The capabilities may be determined based on an input data source and are determined using machine learning.

In operation 204, automatic application flow learning is performed. This operation may also include creation of a repository of objects, web pages, and inactive, or dormant, capabilities. In any case, the automatic application flow is learned using AI. The tested application—web page, API, window page information, etc. will be learned in the AI process which creates the automation object according to the element it recognized.

In operation 206, automated testing for the application is created. The automated testing, such as automation scripts, may be created based on API templates, screenshot captures, etc. The automation scripts will be created automatically according to the process in operation 204.

To this end, the method 200 is able to leverage on AI capabilities to automate the end-to-end automation creation and maintenance process. This significantly reduces the overall automation effort, which would otherwise require manual work, and can exponentially increase automation use across all applications. Furthermore, the method 200 is easily able to adapt existing automation to incoming changes in the application, based on the use of machine learning to determine the application model and application flow. The method 200 may be applied to progression and regression testing, as desired, and can be performed in parallel to application development.

### API AUTOMATION EMBODIMENT

API automation (i.e. automated testing for APIs) may be performed automatically using a feature machine learning capability. API documentation (e.g. WSDL documents, SWAGGER documents, and template XML/Json) may be used to automatically learn and store application capabilities. For a specific document as describe above, the process will learn more than one API including all relevant properties. FIG. 3 illustrates an exemplary GUI for inputting a data source for an application, such as the API documentation. In particular, this is an example of a Simple Object Access Protocol (SOAP) API learning wizard which uses a WSDL document. The AI driven automation enables also other documents such as SWAGGER.

To automate the creation of API automation, information that is required including the APIs to learn are identified, as well as input values, expected results, and a header requirement for each API. Using machine learning on the information, all documented APIs are automatically learned in one execution time. The API outputs can be automatically used within an application flow for validations. The learned capabilities are saved in an automation repository for reuse via a simple drag and drop approach. During the learning process, the user can load also XML/Json example files for using the APIs. These files will help to learn optional values for the input parameters.

### WEB AUTOMATION EMBODIMENT

Web automation (i.e. automated testing for web pages) may be performed automatically using a feature machine learning capability. A web URL corresponding to the application is input. This web URL is all that is needed to automatically learn and store entire web Page Objects Models (POMs) and capabilities.

Using machine learning on the web URL, all web pages are learned in one time. The learned object will include all relevant elements and locators for the specific web page. The learned capabilities are saved in an automation repository for re-use via a simple drag and drop approach. Screenshots may be taken and objects may be automatically associated and stored, to be used offline in a ‘virtualized’ mode for automation creation without the actual application, which may be especially useful in progression testing.

FIGS. 4A-D illustrate exemplary GUIs for automating application capabilities, in the context of the web automation embodiment. FIG. 4A is example of learning wizard for a UI application, e.g. Web or Java desktop application. In FIG. 4A, the GUI enables a user to open new POM using an input web URL corresponding to the application. FIG. 4B presents the learning result from the Web page. In FIG. 4B, the GUI shows the AI driven automation that automatically learns web page capabilities of the application. The learning includes all the relevant elements and locations which connect to the specific element (i.e. the different properties and locators). FIG. 4C displays the elements and the tested application side by side. In FIG. 4C, the GUI shows the POM and capabilities of the application. FIG. 4D displays the created object for the repository. In FIG. 4D, the GUI shows the object created in the resource repository and all capabilities, including screenshots, are now available to automate and run.

### APPLICATION REPAIR EMBODIMENT

As a result of the automated testing, a failure (or numerous failures) of the application may be detected. These failures may be automatically identified and fixed before execution of the application. In one embodiment, automation failures may be automatically identified and a notification for a user may be generated with the delta comparison of broken elements. For automation failures, the model of the application may be automatically re-learned using machine learning, and the failed automation may be fixed. The fixed automation may be automatically deployed to all impacted flows of the application, and may then be executed.

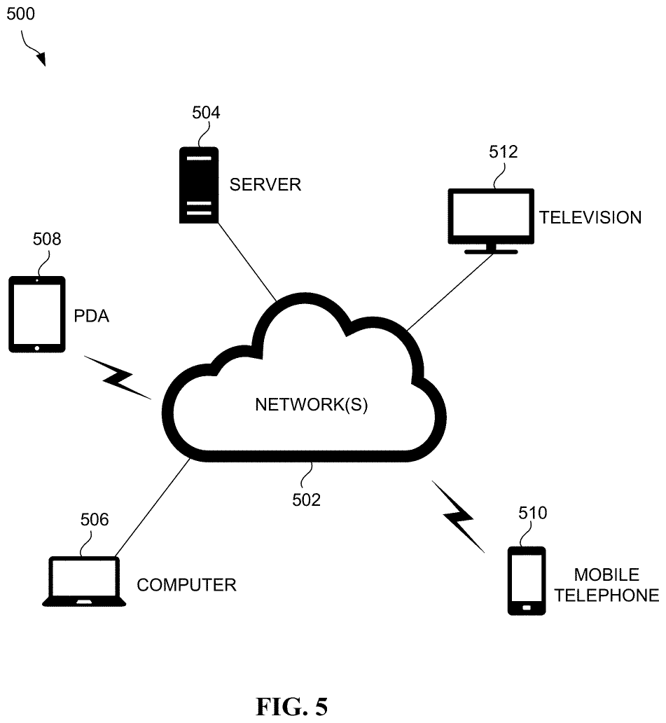

FIG. 5 illustrates a network architecture 500, in accordance with one possible embodiment. As shown, at least one network 502 is provided. In the context of the present network architecture 500, the network 502 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 502 may be provided.

Coupled to the network 502 is a plurality of devices. For example, a server computer 504 and an end user computer 506 may be coupled to the network 502 for communication purposes. Such end user computer 506 may include a desktop computer, lap-top computer, and/or any other type of logic. Still yet, various other devices may be coupled to the network 502 including a personal digital assistant (PDA) device 508, a mobile phone device 510, a television 512, etc. This allows the solution to be platform agnostic and thereby allowing creation of end to end cross platform automation scripts.

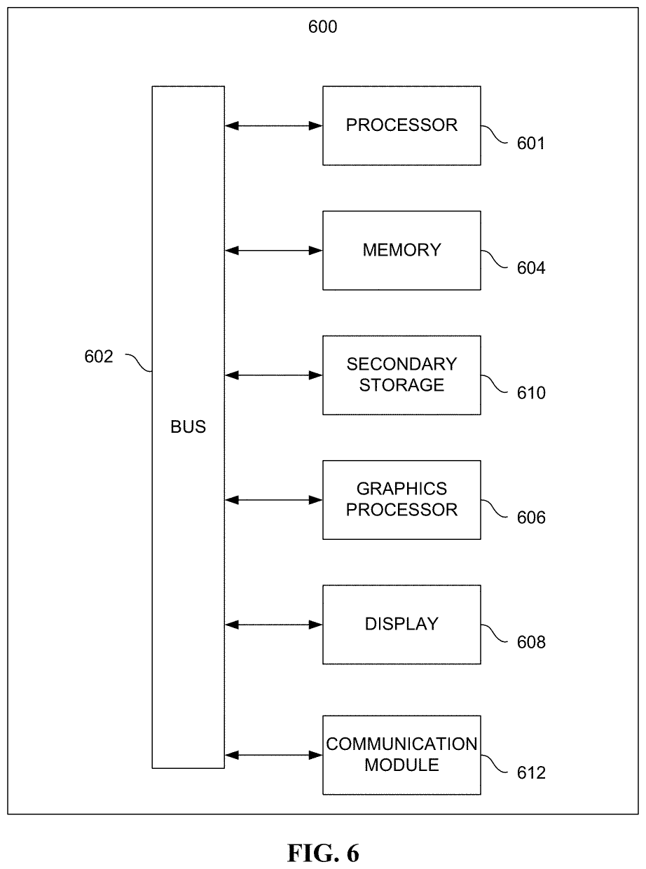

FIG. 6 illustrates an exemplary system 600, in accordance with one embodiment. As an option, the system 600 may be implemented in the context of any of the devices of the network architecture 500 of FIG. 5. Of course, the system 600 may be implemented in any desired environment.

As shown, a system 600 is provided including at least one central processor 601 which is connected to a communication bus 602. The system 600 also includes main memory 604 [e.g. random access memory (RAM), etc.]. The system 600 also includes a graphics processor 606 and a display 608.

The system 600 may also include a secondary storage 610. The secondary storage 610 includes, for example, solid state drive (SSD), flash memory, a removable storage drive, etc. The removable storage drive reads from and/or writes to a removable storage unit in a well-known manner.

Computer programs, or computer control logic algorithms, may be stored in the main memory 604, the secondary storage 610, and/or any other memory, for that matter. Such computer programs, when executed, enable the system 600 to perform various functions (as set forth above, for example). Memory 604, storage 610 and/or any other storage are possible examples of non-transitory computer-readable media.

The system 600 may also include one or more communication modules 612. The communication module 612 may be operable to facilitate communication between the system 600 and one or more networks, and/or with one or more devices through a variety of possible standard or proprietary communication protocols (e.g. via Bluetooth, Near Field Communication (NFC), Cellular communication, etc.).

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™ ), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that several of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-transitory computer readable medium storing computer code executable by a processor to perform a method comprising:
processing one or more input data sources for an application, using Artificial intelligence, to determine one or more Automation objects or nuggets of the application; and
creating automated testing for the application, based on one or more elements displayed in the application.

2. The non-transitory computer readable medium of claim 1, wherein the one or more input data sources include one or more of:
application programming interface (API) documentation defining the application,
a uniform resource locator (URL) to the application, or
an application window.

3. The non-transitory computer readable medium of claim 1, wherein the one or more automation objects or nuggets of the application include capabilities, attributes, and properties of the application.

4. The non-transitory computer readable medium of claim 3, wherein the capabilities of the application are included in:
a frontend of the application,
a backend of the application,
a database utilized by the application, and
APIs of the application.

5. The non-transitory computer readable medium of claim 1, wherein the one or more features of the application include a flow of the application.

6. The non-transitory computer readable medium of claim 1, wherein the one or more features of the application include:
objects within the application,
web pages within the application,
embedded webpages within application,
nested frames and user interface controls within application and
inactive capabilities of the application.

7. The non-transitory computer readable medium of claim 1, further comprising:
creating a repository of the one or more automation objects of the application.

8. The non-transitory computer readable medium of claim 1, wherein the automated testing for the application is created based on at least one of:
API templates,
DOM of the website,
an application window, and
screenshot captures.

9. The non-transitory computer readable medium of claim 1, wherein the automated testing for the application is created in parallel with development of the application.

10. The non-transitory computer readable medium of claim 1, wherein the automated testing for the application includes automated testing of APIs of the application.

11. The non-transitory computer readable medium of claim 1, wherein the automated testing for the application includes automated testing of web pages and mobile devices.

12. The non-transitory computer readable medium of claim 1, wherein the automated testing for the application includes automated testing of windows, PowerBuilder, or any desktop application.

13. The non-transitory computer readable medium of claim 1, further comprising:
executing the automated testing for the application.

14. The non-transitory computer readable medium of claim 1, further comprising:
detecting a failure of the automated testing, by identifying changes in application elements or nuggets.

15. The non-transitory computer readable medium of claim 14, further comprising:
fixing the automated testing, by relearning the application capabilities and identifying a delta.

16. The non-transitory computer readable medium of claim 15, further comprising:
deploying the fixed automated testing to all impacted flows of the application.

17. The non-transitory computer readable medium of claim 16, further comprising:
executing the flow of the application.

18. The non-transitory computer readable medium of claim 1, wherein the automated testing includes progression testing.

19. The non-transitory computer readable medium of claim 1, wherein the automated testing includes regression testing.

20. A method, comprising:
processing one or more input data sources for an application, using machine learning, to determine one or more automation objects or nuggets of the application; and
creating automated testing for the application, based on one or more elements displayed in the application.

21. A system, comprising:
a non-transitory memory storing instructions; and
one or more processors in communication with the non-transitory memory that execute the instructions to perform a method comprising:
processing one or more input data sources for an application, using machine learning, to determine one or more automation objects or nuggets of the application; and
creating automated testing for the application, based on one or more elements displayed in the application.
